(19) United States
(12) Patent Application Publication
(10) Pub. No.: US 2019/0081924 A1
(43) Pub. Date: Mar. 14, 2019

(54) DISCOVERING ADDRESS MOBILITY EVENTS USING DYNAMIC DOMAIN NAME SERVICES

(71) Applicant: LinkedIn Corporation, Sunnyvale, CA (US)

(72) Inventors: Russell I. White, Apex, NC (US); Shafagh Zandi, San Francisco, CA (US)

(73) Assignee: LinkedIn Corporation, Sunnyvale, CA (US)

(21) Appl. No.: 15/700,409

(22) Filed: Sep. 11, 2017

(51) Int. Cl. H04L 29/12; H04L 12/26

(52) U.S. Cl. CPC H04L 61/2076; H04L 41/0816; H04L 43/0811; H04L 61/1511

(57) ABSTRACT

The disclosed embodiments provide a system for discovering address mobility events. Upon detecting a loss of data over a connection with a service at an Internet Protocol (IP) address, the system invalidates a domain name system (DNS) cache on the computer system without waiting for the connection to fail. Next, the system obtains, in response to the invalidated DNS cache, an updated DNS record for the service. The system then uses a new IP address in the updated DNS record to establish a new connection with the service.

### BACKGROUND

### Field

The disclosed embodiments relate to techniques for discovering address mobility events in networks. More specifically, the disclosed embodiments relate to techniques for using dynamic domain name services to discover address mobility events.

### Related Art

Web performance is important to the operation and success of many organizations. In particular, a company with an international presence may provide websites, web applications, mobile applications, databases, content, and/or other services or resources through multiple data centers around the globe. Thus, slow or disrupted access to a service or a resource may potentially result in lost business for the company and/or a reduction in consumer confidence that results in a loss of future business. For example, high latency in loading web pages from the company's website may negatively impact the user experience with the website and deter some users from returning to the website.

During access to websites, web applications, and/or other web-based services or resources, the Domain Name System (DNS) is frequently used to translate human-friendly host names into numeric Internet Protocol (IP) addresses that can be used to locate and identify the corresponding network services using underlying network protocols. As a result, users and/or client applications or devices may reach the services by providing meaningful Uniform Resource Locators (URLs) and email addresses instead of memorizing numeric addresses and/or understanding the underlying mechanisms for locating the services.

However, migration of a web-based service or resource from one network location to another is typically detected by clients only after a significant delay. For example, a client may obtain an IP address of a service from a DNS server and use the IP address to communicate with the service. The service may then be migrated to a new IP address by deploying a new instance of the service at the new IP address and shutting down the existing instance of the service at the IP address. Once the existing instance is taken out of the production, the client may see the service as unreachable, even though another instance of the service is available on the new IP address. The client may then wait until a Transmission Control Protocol (TCP) connection with the IP address has failed and the local DNS cache has timed out to request the new IP address from the DNS server and establish a new connection with the new service instance at the new IP address. Thus, the client's use of features or functionality provided by the service may be interrupted during the period required to time out the connection and the local DNS cache, which can take seconds to minutes.

### BRIEF DESCRIPTION OF THE FIGURES

FIG. 1 shows a system for performing domain name resolution in accordance with the disclosed embodiments.

FIG. 2 shows an exemplary sequence of operations involved in using a dynamic domain name service to discover an address mobility event in accordance with the disclosed embodiments.

FIG. 3 shows a flowchart illustrating a process of communicating with a service in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

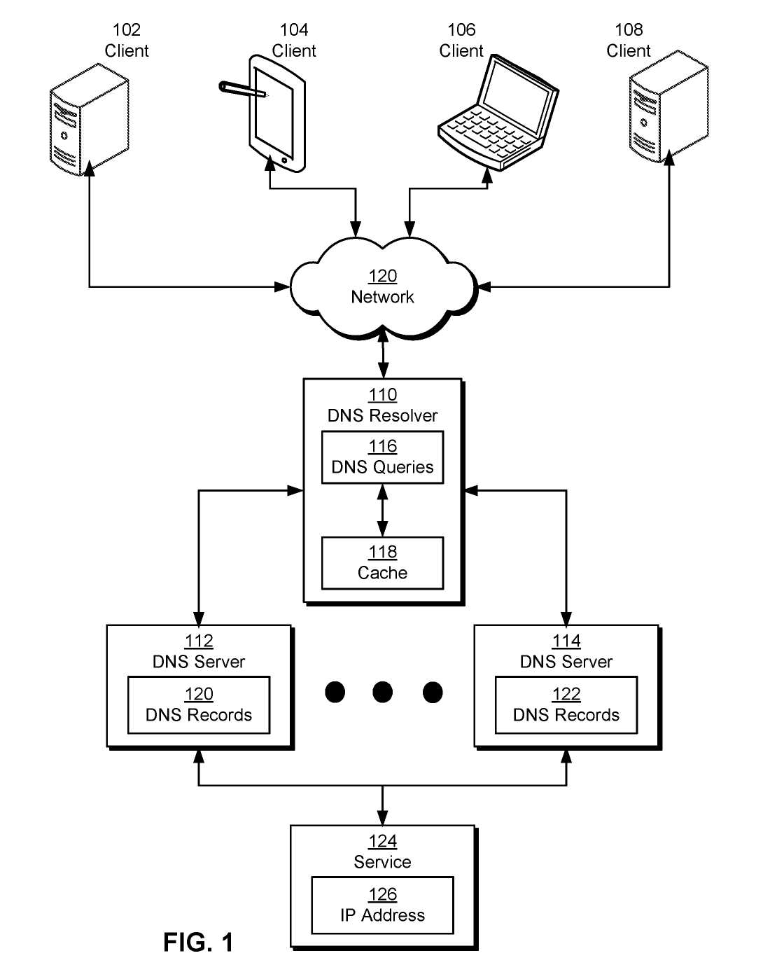

The disclosed embodiments provide a method, apparatus, and system for performing domain name resolution in networks. More specifically, the disclosed embodiments provide a method, apparatus, and system for using dynamic domain name services to discover address mobility events. As shown in FIG. 1, resolution of domain names over a network 120 may be performed by a domain name system (DNS) resolver 110 that processes DNS queries 116 from a set of clients 102-108 and a set of DNS servers 112-114 that interface with DNS resolver 110 to resolve DNS queries 116.

Clients 102-108 may be personal computers (PCs), laptop computers, tablet computers, mobile phones, portable media players, streaming media players, servers, workstations, gaming consoles, and/or other computing devices that are reachable over network 120. Network 120 may include a local area network (LAN), wide area network (WAN), personal area network (PAN), virtual private network, intranet, cellular network, Wi-Fi network (Wi-Fi® is a registered trademark of Wi-Fi Alliance), Bluetooth (Bluetooth® is a registered trademark of Bluetooth SIG, Inc.) network, universal serial bus (USB) network, Ethernet network, and/or switch fabric.

To enable access to services or resources over network 120, an instance of DNS resolver 110 may execute on each client and/or separately from clients 102-108 and resolve Uniform Resource Locators (URLs), email addresses, and/or other human-friendly domain names into Internet Protocol (IP) addresses that can be used by underlying network protocols to locate and identify the corresponding services (e.g., service 124) or resources. For example, DNS resolver 110 may be used to locate a collection of servers that provide advertisements, tracking services, recommendations, articles, posts, status updates, text, fonts, images, audio, video, and/or other components of a web page accessed by the client. In another example, DNS resolver 110 may identify a mail server that can be used to accept email messages from the client to a recipient domain.

DNS resolver 110 may initiate and/or perform a sequence of DNS queries 116 with DNS servers 112-114 to retrieve one or more DNS records 120-122 that are used to resolve a given domain name. For example, DNS resolver 110 may query a root server for a DNS record containing an address of a top-level domain (TLD) name server associated with the domain name. DNS resolver 110 may query the TLD name server and/or additional DNS servers 112-114 in the DNS hierarchy (e.g., using addresses from DNS records 120-122 received from higher-level DNS servers in the hierarchy) until a DNS record that resolves the domain name is received from an authoritative name server. In another example, DNS resolver 110 may initially query a recursive name server that, in turn, queries other DNS servers 112-114 on behalf of DNS resolver 110 to obtain the DNS record. In a third example, DNS resolver 110 and/or a DNS server queried by DNS resolver 110 may retrieve the DNS record from a cache (e.g., cache 118) instead of performing additional queries with other DNS servers (e.g., DNS servers 112-114).

As shown in FIG. 1, service 124 may be assigned an IP address 126 that provided in one or more DNS records (e.g., DNS records 120-122) and used by clients 102-108 to communicate with service 124. For example, each client may use a domain name assigned to service 124 to retrieve, from DNS resolver 110 and/or one or more DNS servers 112-114, a DNS record containing the domain name and IP address 126. The client may then use IP address 126 to send and receive packets over a connection with service 124.

On the other hand, migration of service 124 between servers, virtual machines, containers, clusters, racks, data centers, and/or other network locations may cause a change in the value of IP address 126 assigned to service 124, which in turn may disrupt communication between clients 102-108 and service 124. For example, service 124 may be migrated between two servers by deploying a new instance of service 124 on one server while an old instance of service 124 executes on another server. The new instance may use dynamic DNS to transmit a new IP address for service 124 to DNS servers 112-114 and/or DNS resolver 110, causing one or more DNS records 120-122 for the service to be updated with the new IP address. The old instance may then be removed from production, causing communication between clients 102-108 and the old instance of service 124 to cease. Each client may then wait until the connection with the old IP address has failed and the local DNS cache on the client has timed out before retrieving the updated DNS record from DNS resolver 110 and/or DNS servers 112-114 and establishing a new connection with the new service 124 instance at the new IP address. During the number of seconds to minutes required to establish a connection failure and time out the local DNS cache on the client, communication between the client and service 124 may cease, thereby interrupting the use of data and/or functionality provided by service 124 by the client.

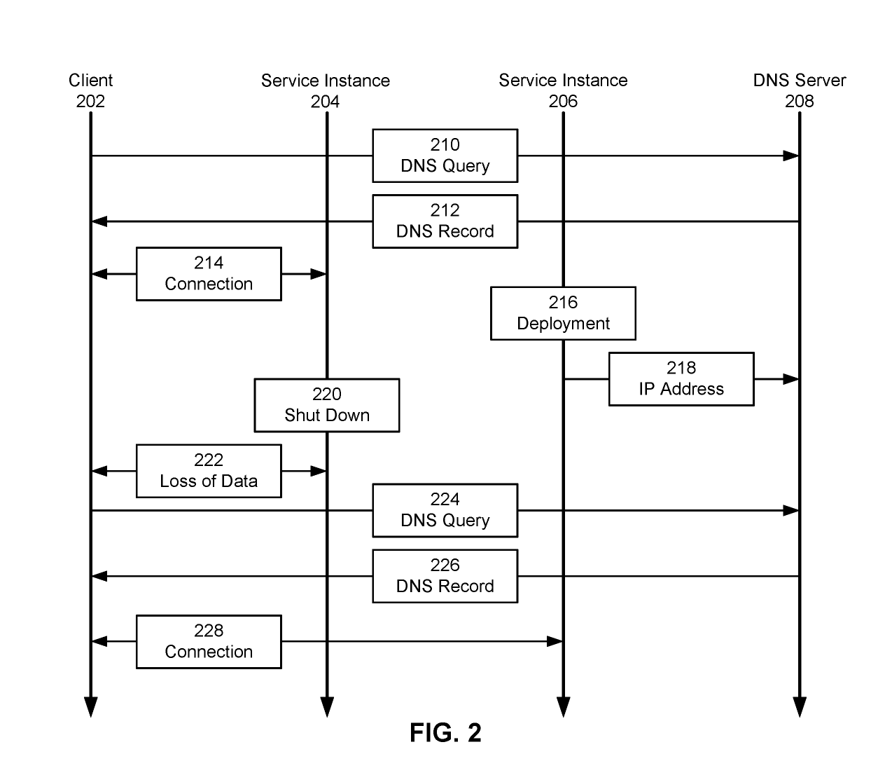

In one or more embodiments, the system of FIG. 1 includes functionality to use dynamic DNS to expedite discovery of address mobility events, such as a change in IP address 126 assigned to service 124 after service 124 is migrated from one location to another. As shown in FIG. 2, a client 202 may establish communication with a service instance 204 by transmitting a DNS query 210 to a DNS server 208 and obtaining a DNS record 212 from DNS server 208 in response to DNS query 210. For example, client 202 may transmit DNS query 210 as a DNS message to DNS server 208. In the “question” section of the DNS message, client 202 may specify a domain name for the service represented by service instance 124 and a record type of “A” or “AAAA.” DNS server 208 may match the domain name and record type to DNS record 212 and transmit a DNS message to client 202 containing the same “question” section and an “answer” section that includes DNS record 212.

After DNS record 212 is retrieved from DNS server 208, client 202 may use an IP address from DNS record 212 to establish a connection 214 with service instance 204. For example, client 202 may use the IP address to send and receive packets that establish a Transmission Control Protocol (TCP) connection 214 and/or other type of communication session with service instance 204. After connection 214 is established, client 202 may use connection 214 to send and receive data with service instance 204. For example, client 202 may obtain files, content, recommendations, posts, search results, articles, updates, images, audio, video, and/or other types of data over connection 214 with service instance 204. In turn, client 202 may use the data to perform tasks and/or provide functionality associated with service instance 204 to one or more users. For example, client 202 may be an electronic device (e.g., personal computer, laptop computer, tablet computer, mobile phone, portable media player, streaming media player, gaming console, etc.) that executes an application for accessing a social network. During use of the application, client 202 may obtain a set of posts and/or recommendations from service instance 204 and display the posts and/or recommendations in a “timeline” and/or “news feed” feature of the social network.

While connection 214 is used by client 202 to communicate with service instance 204, the service represented by service instance 204 may be migrated from one physical and/or virtual location (e.g., server, rack, data center, host, cluster, etc.) to another. The migration may be carried out through deployment 216 of a new service instance 206 for the service at a new network location while the old service instance 204 continues to execute at an old network location represented by the IP address in DNS record 212. After deployment 216, the new service instance 206 may use dynamic DNS to transmit a new IP address 218 for service instance 206 to DNS server 208. In turn, DNS server 208 may create and/or update one or more DNS records (e.g., DNS record 226) with a mapping from the domain name of the service to the new IP address 218 from service instance 206.

To complete the migration of the service, service instance 204 may be shut down 220 sometime after deployment 216 of service instance 206. After service instance 204 is shut down 220, communication between client 202 and service instance 204 may cease, and connection 214 between client 202 and service instance 204 may subsequently fail (e.g., after a number of TCP retransmission attempts).

Instead of waiting for connection 214 to fail without taking action, client 202 may detect a loss of data 222 over connection 214 shortly after service instance 204 is shut down 220. Loss of data 222 may be identified based on one or more thresholds associated with attributes obtained from a transport protocol used to manage connection 214. For example, connection 214 may include a TCP connection. As a result, the attributes may include a failed acknowledgment, and loss of data 222 may be detected as a certain number of consecutive failed acknowledgments over connection 214. The attributes may also, or instead, include a retransmission timeout (RTO) for connection 214, and loss of data 222 may be detected as a RTO that exceeds a certain number of milliseconds and/or a certain number of retransmission attempts after the RTO has lapsed and an acknowledgment is not received. The attributes may also, or instead, include a packet drop count, and loss of data 222 may be detected as a certain number of dropped packets. The attributes may also, or instead, include a window size for a congestion window and/or receive window, and loss of data 222 may be detected when the receive window increases beyond a certain point and/or the congestion window is decreased below a certain point.

Once loss of data 222 is detected, client 202 may invalidate DNS record 212 and/or the local DNS cache in which DNS record 212 is stored.

Because the local DNS cache cannot be relied on to locate the service, client 202 may transmit a DNS query 224 containing the domain name of the service to DNS server 208, and DNS server 208 may respond to DNS query 224 with an updated DNS record 226 containing IP address 218.

Finally, client 202 may use IP address 218 from DNS record 226 to establish a new connection 228 with service instance 206. Client 202 may then use connection 228 to transmit and receive data with service instance 206 instead of service instance 204, thereby restoring the functionality provided by the service. Because connection 228 is established as soon as loss of data 222 over connection 214 is detected, disruption of communication between client 202 and the service may be significantly shortened over conventional techniques that query for updated DNS records only after experiencing transport-layer (e.g., TCP) connection failures that are followed by application- or operating-system-level DNS cache timeouts.

Those skilled in the art will appreciate that components of the system may be implemented in a variety of ways. First, loss of data 222 may be detected by an operating system of client 202 and/or another component with visibility into the transport layer of the network stack on client 202. Loss of data 222 may also, or instead, be detected by an application that receives transport layer information from the component through an application-programming interface (API) and/or one or more system calls. For example, the application may communicate with the service to perform tasks for one or more users of client 202. As a result, the application may interface with the operating system on client 202 to monitor one or more TCP connections with the service and respond to loss of data 222 and/or other connectivity issues associated with the TCP connections.

Second, connection 214 and/or loss of data 222 may be managed using other attributes and/or protocols. For example, connection 214 may be established and/or managed using Quick UDP Internet Connections (QUIC), Structured Stream Transport (SST), Reliable User Datagram Protocol (RUDP), Stream Control Transmission Protocol (SCTP), Datagram Congestion Control Protocol (DCCP), and/or another transport layer protocol that provides windowing, acknowledgments, and/or congestion control. In turn, attributes used by the transport layer protocol to manage connection 214 may be used to detect loss of data 222 before connection 214 is deemed to have failed.

Third, thresholds used to determine loss of data 222 over connection 214 may be adjusted to account for the characteristics of network connections on client 202, the load on DNS server 208, and/or other factors. For example, the lapse in communication between client 202 and the service between shut down 220 of service instance 204 and the creation of connection 228 with service instance 206 may be reduced by lowering the number of failed acknowledgments required to establish loss of data 222 over connection 214. On the other hand, a lower threshold for loss of data 222 may result in additional querying of DNS server 208 in response to normal network events, thus increasing the load on DNS server 208. Consequently, the number of failed acknowledgments required to establish loss of data 222 over connection 214 may be selected to balance the responsiveness of client 202 to address mobility events with additional load on DNS server 208 from increased querying of DNS records.

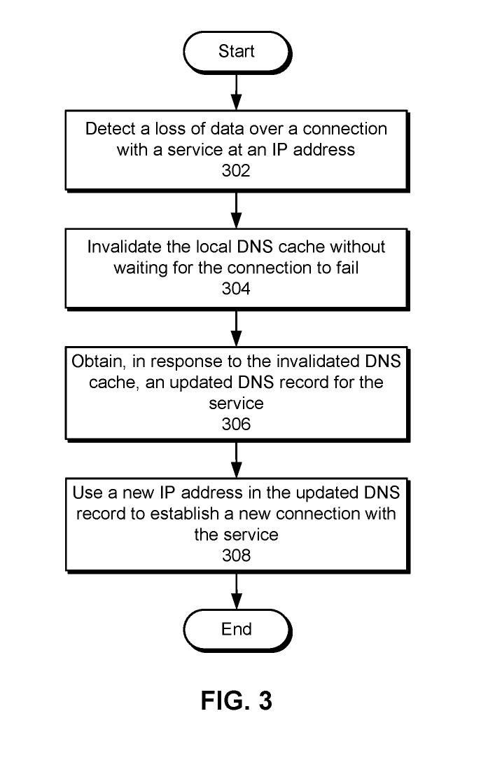

FIG. 3 shows a flowchart illustrating a process of communicating with a service in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a loss of data over a connection with a service at an IP address is detected (operation 302). The loss of data may be detected based on a threshold for an attribute obtained from a transport protocol used to manage the connection. For example, the connection may include a communication session that is established and/or managed using TCP and/or another transport protocol. As a result, the threshold may be specified using a number of failed acknowledgments over the connection, an RTO value and/or a number of retransmission attempts associated with the RTO, a number of dropped packets, and/or a window size associated with a receive window or congestion window.

Once the loss of data over the connection is detected, the local DNS cache is invalidated without waiting for the connection to fail (operation 304). For example, the DNS cache may be invalidated once the connection experiences a certain number of failed acknowledgments instead of waiting for a higher number of failed acknowledgments and/or a certain number of retransmission attempts to establish a TCP connection failure.

In response to the invalidated DNS cache, an updated DNS record for the service is obtained (operation 306). For example, a DNS query containing a domain name of the service may be transmitted to a DNS server and/or DNS resolver, and the updated DNS record may be received in response to the DNS query.

The updated DNS record may be generated using dynamic DNS. For example, the updated DNS record may be generated and propagated by a dynamic DNS server after receiving a new IP address for a new instance of the service. The new instance may be deployed to migrate the service from an old location (e.g., server, host, data center, etc.) represented by the IP address with which the connection is made to a new location (e.g., server, host, data center, etc.) represented by the new IP address. After the new instance is deployed, the new instance and/or new location may use dynamic DNS to transmit the updated DNS record to the DNS server and/or DNS resolver, and an old instance of the service at the old location may be shut down, resulting in the loss of data detected in operation 302.

Finally, the new IP address in the updated DNS record is used to establish a new connection with the service (operation 308). In turn, the new connection may be used to resume communication with the service after the service is migrated from the IP address to the new IP address.

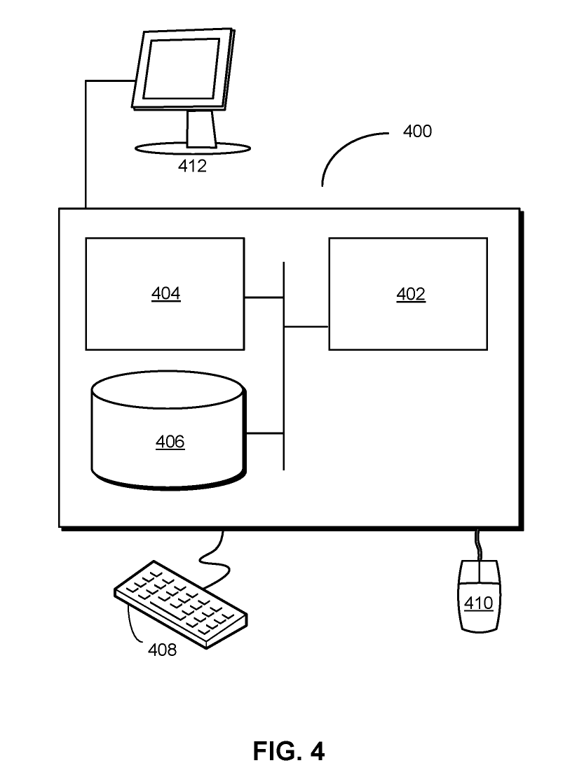

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for the user. To perform tasks for the user, applications may obtain the use of hardware resources on computer system 400 from the operating system, as well as interact with the user through a hardware and/or software framework provided by the operating system.

In one or more embodiments, computer system 400 provides a system for expediting the discovery of address mobility events. The system may include a management apparatus that may alternatively be termed or implemented as a module, mechanism, or other type of system component. The management apparatus may execute on one or more clients. Upon detecting a loss of data over a connection with a service at an IP address, the management apparatus may invalidate a DNS cache on a client without waiting for the connection to fail. Next, the management apparatus may obtain an updated DNS record for the service in response to the invalidated DNS cache. The management apparatus may then use a new IP address in the updated DNS record to establish a new connection with the service.

In addition, one or more components of computer system 400 may be remotely located and connected to the other components over a network. Portions of the present embodiments (e.g., clients, service instances, DNS resolver, DNS server, etc.) may also be located on different nodes of a distributed system that implements the embodiments. For example, the present embodiments may be implemented using a cloud computing system that uses dynamic DNS to discover address mobility events for a set of remote hosts or clients.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
upon detecting, by a computer system, a loss of data over a connection with a service at an Internet Protocol (IP) address, invalidating a domain name system (DNS) cache on the computer system without waiting for the connection to fail;
obtaining, in response to the invalidated DNS cache, an updated DNS record for the service; and
establishing, by the computer system, a new connection with the service using a new IP address in the updated DNS record.

2. The method of claim 1, wherein detecting the loss of data over the connection with the service comprises:
identifying the loss of data based on a threshold for an attribute obtained from a transport protocol used to manage the connection.

3. The method of claim 2, wherein the threshold comprises a number of failed acknowledgments.

4. The method of claim 2, wherein the threshold is associated with a retransmission timeout.

5. The method of claim 2, wherein the threshold comprises a number of dropped packets.

6. The method of claim 2, wherein the threshold comprises a window size associated with a receive window or a congestion window.

7. The method of claim 2, wherein the transport protocol comprises Transmission Control Protocol (TCP).

8. The method of claim 1, wherein obtaining the updated DNS record for the service comprises:
transmitting a DNS query comprising a domain name of the service; and
receiving the updated DNS record in response to the DNS query.

9. The method of claim 8, wherein the updated DNS record is received from at least one of:
a DNS resolver; and
a DNS server.

10. The method of claim 1, wherein the loss of data over the connection with the service and the updated DNS record for the service are associated with migrating the service from the IP address to the new IP address.

11. The method of claim 1, wherein the updated DNS record is generated from the new IP address of the service using dynamic DNS.

12. An apparatus, comprising:
one or more processors; and
memory storing instructions that, when executed by the one or more processors, cause the apparatus to:
upon detecting a loss of data over a connection with a service at an Internet Protocol (IP) address, invalidate a domain name system (DNS) cache on the computer system without waiting for the connection to fail;
obtain, in response to the invalidated DNS cache, an updated DNS record for the service; and
establish a new connection with the service using a new IP address in the updated DNS record.

13. The apparatus of claim 12, wherein detecting the loss of data over the connection with the service comprises:
identifying the loss of data based on a threshold for an attribute obtained from a transport protocol used to manage the connection.

14. The apparatus of claim 13, wherein the threshold is associated with at least one of:
a number of failed acknowledgments;
a retransmission timeout;
a number of dropped packets; and
a window size associated with a receive window or a congestion window.

15. The apparatus of claim 12, wherein obtaining the updated DNS record for the service comprises:
transmitting a DNS query comprising a name of the service; and
receiving the updated DNS record in response to the DNS query.

16. The apparatus of claim 12, wherein the loss of data over the connection with the service and the updated DNS record for the service are associated with migrating the service from the IP address to the new IP address.

17. The apparatus of claim 12, wherein the updated DNS record is generated from the new IP address of the service using dynamic DNS.

18. A system, comprising:
a management module in each of a set of client devices, wherein the management module comprises a non-transitory computer-readable medium comprising instructions that, when executed, cause a client device to:
upon detecting a loss of data over a connection with a service at an Internet Protocol (IP) address, invalidate a domain name system (DNS) cache on the computer system without waiting for the connection to fail;
obtain, in response to the invalidated DNS cache, an updated DNS record for the service; and
establish a new connection with the service using a new IP address in the updated DNS record.

19. The system of claim 18, further comprising:
a first server that hosts the service at the IP address; and
a second server that hosts the service at the new IP address and uses dynamic DNS to generate the updated DNS record.

20. The system of claim 18, wherein the loss of data over the connection with the service is detected using at least one of:
a number of failed acknowledgments;
a retransmission timeout;
a number of dropped packets; and
a window size associated with a receive window or a congestion window.
